(19) United States
(12) Patent Application Publication
(10) Pub. No.: US 2024/0391556 A1
(43) Pub. Date: Nov. 28, 2024

(54) CONTROL UNIT AND METHOD FOR USE IN AN INTERMEDIATE CIRCUIT

(71) Applicant: MOVARIA GmbH, Munich (DE)

(72) Inventors: Felix Ballendat, Munich (DE); Jakob Karbaumer, Munich (DE)

(21) Appl. No.: 18/645,526

(22) Filed: Apr. 25, 2024

(30) Foreign Application Priority Data
May 22, 2023 (DE) 10 2023 113 286.5

(51) Int. Cl. B62M 6/50; B62M 6/55; B62M 6/90

(52) U.S. Cl. CPC B62M 6/50; B62M 6/55; B62M 6/90

(57) ABSTRACT

A control unit is used in an intermediate circuit of a vehicle that electrically connects a generator and an electric drive. The control unit includes a control module to receive a setpoint value as a reference variable and an actual value as a control input and to output a control variable. The control input and reference variable have the same physical dimension. An evaluation module determines an actuating variable from the control variable. The actuating variable influences the control input such that the actual value approaches the setpoint value. A drive interface communicates with the electric drive. The control unit further includes a generator interface to receive a parameter from the generator. The control unit determines an intermediate circuit voltage in the intermediate circuit and uses it as a control input. A drive power of an electric drive can be adapted to an output power of a generator.

### CROSS-REFERENCE TO RELATED APPLICATION(S)

This application claims priority under 35 U.S.C. § 119 to German Application No. 10 2023 113 286.5, filed on May 22, 2023, the content of which is incorporated by reference herein in its entirety.

### FIELD

The present disclosure relates to a control unit for use in an intermediate circuit of a vehicle, in particular a chainless cargo bike, wherein the intermediate circuit electrically connects a generator and an electric drive. The present disclosure further relates to a method for adapting a drive power of an electric drive of a vehicle, in particular of a chainless cargo bike, to an output power of a generator of the vehicle.

### BACKGROUND

A chainless cargo bike is known from the European patent application EP 2 876 029 A2. Chainless cargo bikes are powered by an electric drive. This draws the power required for the drive from a drive battery unit. A generator can be provided in a pedal crank of the cargo bike so that the cranks are connected to the generator to support the drive battery unit. This converts the mechanical energy supplied to the pedal crank into electricity. Typically, the proportion of power that the drive battery unit provides to the electric drive is many times, in particular 10 to 100 times, higher than the proportion of power that the generator provides to the electric drive. In the case of chainless cargo bikes, there is no mechanical power transmission, for example in the form of a bicycle chain.

### SUMMARY

It is an objective of the present disclosure to reduce the disadvantages of the prior art and to provide an improved control unit for use in an intermediate circuit, i.e. a DC link, of a vehicle, in particular of a chainless cargo bike, and an improved method for adapting a drive power of an electric drive of a vehicle, in particular of a chainless cargo bike. In particular, the present disclosure aims at being able to move a chainless cargo bike even when a drive battery unit of a chainless cargo bike does not provide power. Furthermore, the present disclosure particularly aims at a robust control of the chainless cargo bike.

The objective is solved by a device and a method according to the independent claims. Advantageous further embodiments are shown in the dependent claims, the description and the figures.

Accordingly, a control unit for use in an intermediate circuit of a vehicle, in particular a chainless cargo bike, is proposed, the intermediate circuit electrically connecting a generator and an electric drive, for example an electric motor. The generator can convert a pedalling movement of a user into electric current, which in turn is fed to the electric drive. The control unit has a control module which is configured for this purpose, i.e. is configured and intended to receive a setpoint value as a reference variable and an actual value as a control input and to output a control variable as control output, the control input and the reference variable having the same physical dimension, i.e. being measured in the same physical unit, in particular volts. The control unit also has an evaluation module which is configured to determine an actuating variable from the control variable, in particular to calculate it, wherein the actuating variable influences the control input at least indirectly in such a way that the actual value approaches the setpoint value. The control unit can also have a generator interface which is configured to receive a generator parameter from the generator, in particular a value of a generator power, i.e. a generator output power. The control unit has a drive interface that is configured to communicate with the electric drive. The control unit is configured to determine an intermediate circuit voltage that is present in the intermediate circuit and to use it as a control input. The intermediate circuit voltage can be determined using a voltage measuring device. It can also be determined using a current measuring device and subsequent conversion. The measuring device can be integrated into the control unit, for example. The inventors have discovered that the intermediate circuit voltage is the decisive parameter for keeping an intermediate circuit stable, to which, in particular, only a fluctuating pedal power is supplied. The control unit makes it possible to operate the vehicle, in particular the chainless cargo bike, reliably, enduringly and robustly, even if only fluctuating power is supplied to the intermediate circuit as input power. For example, a chainless cargo bike can be operated even if a drive battery unit does not provide any power.

In one embodiment, the control unit has a status detector that is configured to detect whether a drive battery unit is actively connected to the intermediate circuit, i.e. whether the intermediate circuit is battery-powered. For example, a battery interface can inform the control unit whether the drive battery unit is able to provide power to the intermediate circuit, i.e. whether it is actively connected to the intermediate circuit. This may not be the case, for example, if the drive battery unit is discharged, defective or removed. As soon as the status detector detects that the drive battery unit is actively connected to the intermediate circuit, the control unit can operate in a first configuration. If the status detector detects that the drive battery unit is not actively connected to the intermediate circuit, i.e. that the intermediate circuit has no batteries, the control unit can operate in a second configuration. In particular, in the second configuration, the control unit is configured to use the intermediate circuit voltage as a control variable. The control according to the disclosure by the control module and the evaluation module of the control unit is only used in particular when the drive battery unit is not actively connected to the intermediate circuit, i.e. when the latter is without battery. In this way, efficient control and regulation is achieved in both the battery-operated configuration and the battery-free configuration.

In one embodiment, the control unit is configured to, in the state in which the drive battery unit is not actively connected to the intermediate circuit, deactivate a brake of the electric drive, which can absorb a torque acting in the opposite direction to the drive direction, i.e. a negative torque. A negative torque is referred to as a torque acting in the opposite direction to the drive direction. The negative torque can therefore occur when the vehicle brakes during a forward movement. It can also occur when the vehicle brakes during a reverse movement. By braking this torque, power could be taken from the electric drive and supplied to the intermediate circuit, but this would have a detrimental effect on the intermediate circuit voltage and the generator. The control unit therefore deactivates the brake. If a negative torque occurs, there is therefore no power exchange from the electric drive to the intermediate circuit. The power that can be generated from the torque is therefore not supplied to the intermediate circuit.

In one embodiment, the control unit has a switch apparatus for opening and closing a battery switch which is arranged between the drive battery unit and the intermediate circuit, wherein the switch apparatus is configured to open the battery switch when the status detector has detected that the drive battery unit is not actively connected to the intermediate circuit, wherein the battery switch is in particular part of a battery management system of the drive battery unit. The switch apparatus in conjunction with the battery switch can ensure that the power supplied to the intermediate circuit does not flow into the drive battery unit, but can be used as drive power.

In one embodiment, the actuating variable is a drive power of the electric drive, wherein the drive interface is configured to indicate the drive power to the electric drive so that the intermediate circuit voltage is adjustable via the drive power. In this way, the intermediate circuit voltage can be adapted to the setpoint by specifying the drive power. In particular, the intermediate circuit voltage decreases when the drive power is higher than the generator power and the intermediate circuit voltage increases when the drive power is lower than the generator power. The drive power is suitable as a control variable as it can be adjusted without delay. This contributes to robust control.

In one embodiment, the control unit has a generator interface which is configured to receive a generator parameter from the generator, in particular a value of a generator power, i.e. a generator output power. The generator interface is configured to activate the generator only when the intermediate circuit voltage has reached a first threshold value. In particular, the control module can be configured to output the control variable only when the intermediate circuit voltage has reached a first threshold value. As soon as the generator is activated, not only can its power be detected, but its power can also be increased, for example by activating and/or increasing a pedal resistance of the generator. In the case of the cargo bike, this makes it more difficult for the user to pedal. In the battery-free state, it can thus be ensured that the control unit has first been supplied with sufficient power before it communicates with the evaluation module. This further increases the robustness of the control system because it can react to fluctuating power inputs. The first threshold value can be set variably. For example, it is a threshold voltage that is greater than 10 V and less than 80 V, in particular between 20 V and 30 V. If it is a chainless cargo bike, the first threshold value can be exceeded, for example, if the pedal crank has been rotated by a quarter turn with a corresponding torque.

In one embodiment, the drive interface is configured to output the actuating variable to the electric drive only when the intermediate circuit voltage has exceeded a second threshold value. In the battery-free state, this ensures that the control unit has first been supplied with sufficient power before it communicates with the electric drive. This further increases the robustness of the control system because it can react to fluctuating power inputs. In this way, power is only supplied to the electric drive when a sufficiently high voltage is already present in the intermediate circuit. For example, this is a threshold voltage that is greater than 40 V and less than 100 V, in particular between 50 V and 70 V. The second threshold voltage can correspond to the setpoint value of the intermediate circuit voltage or be slightly below it, for example 5% below the setpoint value. Before the second threshold value is exceeded, the pedal resistance of the generator can be increased continuously and differentiably so that, for example, more force is required for a pedalling movement.

In one embodiment, the evaluation module determines the actuating variable by means of a factor with which the generator parameter is to be calculated, in particular multiplied, in order to obtain the drive power as the actuating variable. In particular, the generator parameter fluctuates greatly over time because it can be proportional to the pedal power supplied. By linking the actuating variable, in particular the drive power, with the generator parameter, in particular the generator power, a coupling of the power supply with the power extraction can be achieved. This is beneficial for reliable control. In this respect, the evaluation module can act as a manipulating device on the controlled path, which indicates an actuating variable from the control variable output by a controller, on the basis of which the vehicle is controlled.

In one embodiment, the factor varies as a function of the generator parameter and, in particular, lies in a range between 0.5 and 1.5, in particular 0.8 and 1.2. If the factor is 0.5, half of the generator power is indicated as the motor power. If it is 1.5, on the other hand, 1.5 times the generator power is indicated as the motor power. Due to friction losses, for example, the factor can usually be less than 1 and can only be set to a value above 1 in exceptional situations. The fluctuations in the factor and the associated fluctuations in the correlation between generator power and drive power are made possible by capacities within the intermediate circuit.

In one embodiment, the control unit is configured to decrease the drive power of the drive when the generator parameter is decreased in order to increase the intermediate circuit voltage, and/or increase the drive power of the drive when the generator parameter is increased in order to decrease the intermediate circuit voltage.

In one embodiment, the generator parameter depends, in particular exclusively, on a fluctuating pedalling power, in particular proportionally, which a user applies to the vehicle. The generator parameter can be proportional to the pedalling power. In the case of a cargo bike, the power of the generator depends on how hard a user pedals. The generator parameter is usually in a range between 20 W and 200 W, depending on the user's power.

In one embodiment, the setpoint value of the intermediate circuit voltage can be pre-set and the actual value of the intermediate circuit voltage deviates by less than 15%, in particular less than 10%, from the setpoint value of the intermediate circuit voltage, wherein the deviation depends on a clocking of the control unit. The setpoint value of the intermediate circuit voltage can be communicated to the control unit via a communication interface and can therefore be pre-set. The setpoint value of the intermediate circuit voltage can vary with an operating state in which the vehicle, in particular the chainless cargo bike, is operated. For example, it can be higher when driving downhill than when driving uphill. Alternatively, the setpoint value of the intermediate circuit voltage can be constant regardless of the state. The control unit can be clocked such that the drive power is always adapted as a control variable so that the actual value of the intermediate circuit voltage does not deviate from the setpoint intermediate circuit voltage by more than 15%. The higher the clocking, the smaller the deviation and the higher the power consumption. This represents an efficient compromise between the power consumption of the control unit and the control efficiency of the controlled path.

In one embodiment, a generator unit is provided for being integrated into an intermediate circuit. The generator unit includes a control unit according to the disclosure and a generator according to the disclosure, which can be integrated in particular in a pedal crank of a cargo bike or in a hand crank, for example in wheelchair vehicles, so that the cranks are connected to the generator. The generator can also be integrated into a linear unit that undergoes a linear drive movement instead of a circular drive movement. The generator unit can be designed as an independent component.

In one embodiment, a vehicle is provided that includes a generator unit according to the disclosure, a motor unit and an intermediate circuit according to the disclosure. The motor unit comprises the electric drive and a drive control unit for adapting a drive power of the electric drive. In the vehicle, the electric drive and the generator are coupled to each other purely electrically. In this respect, they are chain-free, i.e. without mechanical power transmission from the generator to the drive.

In one embodiment, the vehicle has a drive battery unit that can be optionally connected to the intermediate circuit, wherein, in particular, a status detector detects whether the drive battery unit is actively connected to the intermediate circuit. This is the same status detector as that in one embodiment of the control unit. If the status detector detects that the drive battery unit is actively connected to the intermediate circuit, i.e. the intermediate circuit is battery-powered, the control unit operates in a first configuration. If the status detector detects that the drive battery unit is not actively connected to the intermediate circuit, i.e. the intermediate circuit is battery-free, the control unit can operate in a second configuration. In particular, in the second configuration, the control unit is configured to use the intermediate circuit voltage as a control input. The control according to the disclosure by the control module and the evaluation module of the control unit is only used in particular when the drive battery unit is not actively connected to the intermediate circuit, i.e. when the latter is battery-free. In this way, efficient control and adjustment is achieved in both the battery-operated configuration and the battery-free configuration.

In one embodiment, the vehicle is a chainless cargo bike having a pedal crank and an assembly, in particular a rear wheel assembly, wherein the generator is integrated into the pedal crank so that the cranks are connected to the generator and the electric drive is integrated into the rear wheel assembly. The rear wheel assembly can have a rear wheel hub and a rear wheel axle. It is also possible to integrate the electric drive in other assemblies, in particular in other axles, such as a front wheel axle.

Furthermore, a method for adapting a drive power of an electric drive of a vehicle, in particular a chainless cargo bike, to an output power of a generator of the vehicle is also proposed. The method comprises the following steps: The step of determining an actual value of an intermediate circuit voltage present in an intermediate circuit electrically connecting the generator and the electric drive. The intermediate circuit voltage can be determined using a voltmeter. It can also be determined using a current meter and subsequent conversion. The measuring device can be integrated into the control unit, for example. The method also comprises the step of determining a generator parameter, in particular a generator power, in particular which depends on a fluctuating pedal power which a user applies to the vehicle. The generator power can be determined by the generator and communicated to the control unit via the generator interface. The method comprises further the step of determining a setpoint value of the intermediate circuit voltage, in particular which can be pre-set. The setpoint value of the intermediate circuit voltage can be essentially constant or vary depending on the state of the vehicle. The method comprises further the step of determining a control deviation between the actual value of the intermediate circuit voltage and the setpoint value of the intermediate circuit voltage. The method comprises further the step of adapting the drive power of the electric drive as a function of the control deviation. The determined voltage difference can be used as a control deviation to adjust the drive power. This method can be implemented, for example, by a control unit according to the disclosure. In this respect, it offers the same advantages and has the same effects as the control unit according to the disclosure.

In one embodiment, the following steps are carried out after the control deviation has been determined and before the drive power is adapted: The step of determining a factor by means of which a drive power results from the generator power, in particular by multiplying the generator power by the factor, and determining the drive power. The factor may be the factor described above in connection with the control unit. Reference is made to the corresponding disclosure. The step of transmitting the drive power to a drive control unit is also carried out. Furthermore, the step of adapting the drive power of the electric drive to the transmitted drive power is carried out in order to adapt the actual value of the intermediate circuit voltage to the setpoint value of the intermediate circuit voltage.

In one embodiment, the process steps are carried out continuously in order to variably determine the drive power with the fluctuating generator power such that the substantially constant setpoint value of the intermediate circuit voltage is continuously controlled. For example, a timing can be indicated with which the individual components responsible for determining the actual value of the intermediate circuit voltage, for determining the generator power, for determining the setpoint value of the intermediate circuit voltage and for determining the control deviation determine the respective values. The timing is such that the steps run continuously. In particular, it can be configured so that the actual value deviates by less than 15%, in particular less than 10%, from the setpoint value of the intermediate circuit voltage.

In one embodiment, the generator power is only detected when the intermediate circuit voltage has exceeded a first threshold value. This first threshold value may be the first threshold value disclosed in connection with the control unit. Reference is made to the corresponding disclosure.

In one embodiment, the drive power is only performed when the intermediate circuit voltage has exceeded a second threshold value. This second threshold value may be the second threshold value disclosed in connection with the control unit. Reference is made to the corresponding disclosure.

### BRIEF DESCRIPTION OF THE DRAWINGS

Preferred further embodiments of the present disclosure are explained in more detail in the following description of the figures.

FIG. 1 shows a schematic view of a cargo bike;

FIG. 2 shows a schematic view of various components for driving a vehicle;

FIG. 3 shows a schematic circuit diagram of an intermediate circuit;

FIG. 4 shows a block diagram of a controlled path;

FIG. 5 shows a flow chart of various states;

FIG. 6 shows the behavior of various components in different states; and

FIG. 7 shows different states in the torque-speed diagram.

### DETAILED DESCRIPTION

Preferred embodiments are described below with reference to the figures. Here, identical, similar or similarly acting elements in the different figures are provided with identical reference signs, and a repeated description of these elements is partially dispensed with in order to avoid redundancies.

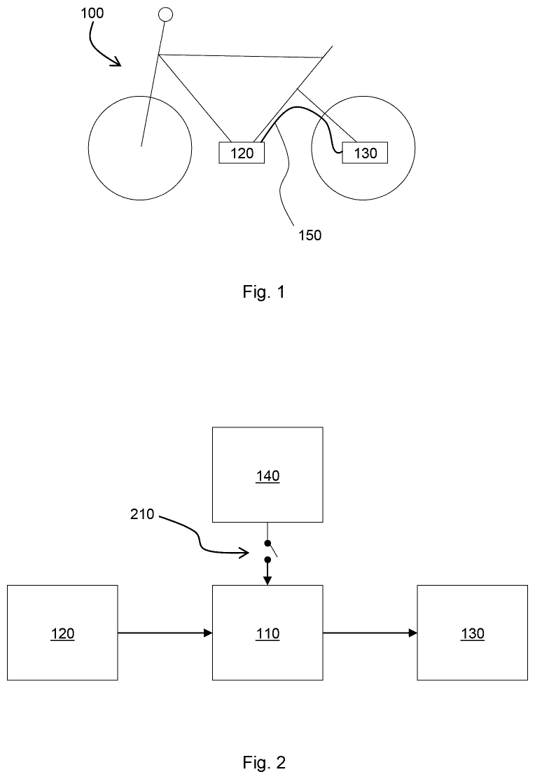

FIG. 1 schematically shows a cargo bike 100. The cargo bike 100 is designed to transport loads. A generator 120 is fitted in the area of a pedal crank. The generator 120 can be used to convert the power mechanically input by a user via the pedal crank into electric current. The electric current is fed to an electric drive 130 via an electric cable 150. The mechanical power input by the user is thus completely converted into electric current-after deducting unavoidable losses-so that the cargo bike 100 is chainless. The generator 120 and the electric drive 130 are coupled together purely electrically.

FIG. 2 schematically shows the components involved in the electrical coupling between the generator 120 and the electric drive 130. An intermediate circuit 110 is provided between the generator 120 and the electric drive 130 as a circuit for electrically connecting the generator 120 to the electric drive 130. A drive battery unit 140 may be connected to the intermediate circuit 110. A status detector detects whether the drive battery unit 140 is actively connected to the intermediate circuit 110 or not. In FIG. 2, a battery switch 210 is schematically shown between the drive battery unit 140 and the intermediate circuit 110. The battery switch 210 can communicate with a switch device and be opened when the status detector has detected that the drive battery unit 140 is not actively connected to the intermediate circuit 110. In particular, the drive battery unit 140 is not actively connected to the intermediate circuit 110 when it is discharged, defective or removed. Thus, if the battery switch 210 is open, the drive battery unit 140 is not actively connected to the intermediate circuit 110; if it is closed, the drive battery unit 140 is actively connected to the intermediate circuit 110. If, for example, the drive battery unit 140 is discharged, defective or removed, the status detector recognizes that the drive battery unit 140 is not actively connected to the intermediate circuit 110 and subsequently opens the battery switch 210. This ensures that any power supplied to the intermediate circuit 110 by the generator 120 is fully made available to the electric drive, taking into account unavoidable losses, and that the supplied power does not flow into the drive battery unit 140.

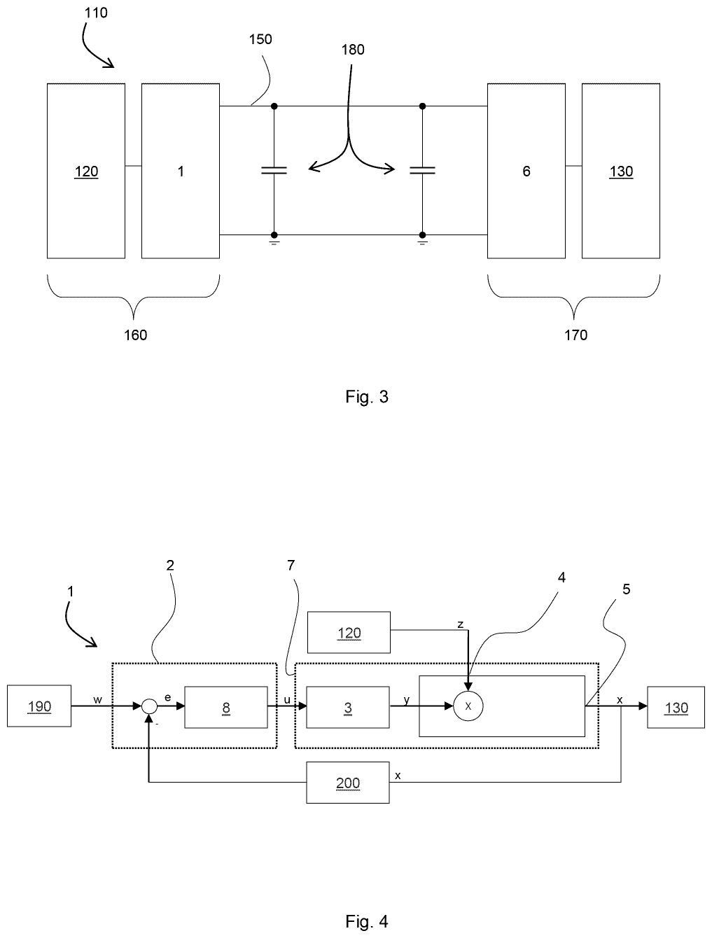

FIG. 3 shows the intermediate circuit 110 schematically. A control unit 1 is connected to the generator 120. Together, the generator 120 and the control unit 1 form a generator unit 160. The generator unit 160 can be integrally designed as an independent component. A drive control unit 6 is connected to the electric drive 130. Together, the electric drive 130 and the drive control unit 6 form a motor unit 170, which can also be integrally designed as an independent component. The generator 120 and the electric drive 130 are connected to each other via the intermediate circuit 110. In addition to the control unit 1 and the drive control unit 6, the intermediate circuit 110 has an intermediate circuit capacitance, which is realized, for example, via capacitors 180 connected in parallel. The intermediate circuit capacitance can, for example, be integrated into the control unit 1 and/or the drive control unit 6, so that it is part of the generator unit 160 and/or the motor unit 170. An AC/DC converter can be arranged downstream of the generator 120, and a DC/AC converter can be arranged upstream of the electric drive 130, so that the generator 120 produces an alternating current, which is converted into a direct current for the intermediate circuit 110, which in turn is converted into an alternating current for the electric drive 130. The generator unit 160 can be integrated into the pedal crank of the cargo bike 100 so that the cranks are connected to the generator. It is also possible for only the generator 120 to be integrated into the pedal crank and for the control unit 1 to be housed at a different location. The motor unit 170 can be integrated into a rear wheel hub of the cargo bike 100. It is also possible for only the electric drive 130 to be integrated into the rear wheel hub and for the drive control unit 6 to be housed in a different location. The generator unit 160 and the motor unit 170 are connected to each other via electrical cables 150. A mechanical connection beyond the electrical cable 150 is not provided.

FIG. 4 is a block diagram of a control circuit of the intermediate circuit 110, which is controlled via a control unit 1. In one embodiment, the functions realized by the control unit 1 can be at least partially taken over by the drive control unit 6. A setpoint value of the intermediate circuit voltage U_{Z} is indicated to the control circuit as a reference variable w via an input module 190. This setpoint can be between 40 and 100 V, in particular 50 V. In one embodiment, the input module 190 can be controlled so that the setpoint value of the intermediate circuit voltage U_{Z} is adjustable. The setpoint value of the intermediate circuit voltage U_{Z} can be constant. It can also be adjustable to fluctuate around a constant value so that the setpoint takes external influencing factors, such as a disturbance variable z, into account. In addition to the setpoint value of the intermediate circuit voltage UZ as a reference variable w, an actual value of the intermediate circuit voltage U_{Z} is fed to a control module 2 as a control input x. The control input x is recorded by a measuring module 200 of the control unit 1. The control module 2 first determines a control deviation e between the setpoint value of the intermediate circuit voltage U_{Z} and the actual value of the intermediate circuit voltage UZ, for example by means of a summator. From this control deviation e, the control module determines an error, in particular in the form of a voltage difference. A controller 8, which is designed for example as a PID controller or PI controller, determines a control variable u from the control deviation. A controlled path 7, to which the control variable u is fed, is connected to the control module 2. The controlled path 7 acts directly or indirectly on the intermediate circuit voltage U_{Z} as the control variable x via the ratio of the electrical outputs of the generator 120 and the electric drive 130. The control deviation can be influenced by the occurrence of disturbance variables z in the controlled path 7, for example by the varying supply of generator power and additionally by changes in the environment or the terrain in which the vehicle is located, or by a change in the setpoint value of the intermediate circuit voltage, i.e. the reference variable.

An evaluation module 3 as an adjuster receives the control variable u and determines an actuating variable y from it. The actuating variable y is a drive power of the electric drive 130. If the drive power of the electric drive 130 is increased, the intermediate circuit voltage decreases; if the drive power of the electric drive 130 is decreased, the intermediate circuit voltage increases. The control unit 1 has a generator interface 4, via which the control unit 1 and the generator 120 can communicate with each other, so that the control unit 1 is informed of a generator parameter, in particular a value of the generator power. In addition, the control unit 1 has a drive interface 5, via which the control unit 1 and the electric drive 130 can communicate with each other, so that the control unit 1 and the electric drive 130 exchange signals relating to the drive power of the electric drive 130.

Let us assume the case that the vehicle is a chainless cargo bike 100 with an electric drive 130: The electric drive 130 and thus the chainless cargo bike 100 is driven by means of the drive battery unit 140 in a battery-powered state, i.e. a state in which the drive battery unit 140 is actively connected to the intermediate circuit 110. In addition, the electric drive 130 can be supported by the generator 120, which converts the power of a user into electric power. The intermediate circuit 110 is provided between the generator 120, the electric drive 130 and the drive battery unit 140. In the battery-powered state, the intermediate circuit 110 is thus supplied with power by the drive battery unit 140 and the generator 120. The power provided by the drive battery unit 140 is many times higher than the power provided by the generator 120. In the battery-powered state, therefore, most of the drive power comes from the drive battery unit 140. For example, if we assume the voltage as a power-indicating parameter, 90% of the voltage required by the electric drive 130 is provided by the drive battery unit 140 and 10% by the generator 120.

This is in contrast to a battery-free state, i.e. a state in which the drive battery unit 140 is not actively connected to the intermediate circuit 110 and the drive battery unit 140 does not provide any drive power to the intermediate circuit 110. If the same configuration of the control unit 1 prevailed in the battery-free state as in the battery-operated state, the intermediate circuit 110 would immediately collapse. This is because the electric drive 130 would expect many times more power than the power then provided exclusively by the generator 120. The control unit 1 according to the disclosure therefore has a configuration for the battery-free state in addition to the configuration for the battery-operated state. Whether the battery-operated or the battery-free state is in the context of can be detected via a state detector. In the battery-free state, the chainless cargo bike 100 can be operated as follows:

For example, a user supplies the generator 120 with increased power. This is converted into electrical current and fed to the intermediate circuit 110. The generator interface 4 of the control unit 1 receives the value of the generator output from the generator 120. After a corresponding activation, namely exceeding a threshold value as described below, the intermediate circuit 110 initially has essentially the setpoint value of the intermediate circuit voltage. The intermediate circuit voltage increases due to the increased power supplied by the generator. The corresponding actual value of the intermediate circuit voltage is detected by the measuring module 200 and fed to the control module 2. The control module 2 detects a control deviation between the actual value of the intermediate circuit voltage and the setpoint value of the intermediate circuit voltage. In the context of the disclosure, the intermediate circuit voltage has increased due to the increased power supply by the user. In order for the intermediate circuit voltage to approach the setpoint value again, the evaluation module 3 calculates a value by which the drive power of the electric drive 130 should increase so that the intermediate circuit voltage decreases again. The control unit 1 communicates this value to the electric drive 130 via the drive interface 5. This increases its power accordingly, which leads to a drop in the intermediate circuit voltage. In this way, a chainless cargo bike 100 can also be operated when no drive battery unit 140 is active, for example because it is removed, defective or discharged. Thus, the power that is supplied to the intermediate circuit 110 via the generator 120 can be taken from the intermediate circuit 110 via the electric drive 130 in a ratio of essentially 1 to 1 by keeping the intermediate circuit voltage essentially constant as a control input. If a comparison of the actual value with the setpoint value shows that the intermediate circuit voltage is too high, the following happens: in order to reduce the intermediate circuit voltage, the drive control unit 6 is informed that the electric drive 130 should consume more power, i.e. the current. This means that more power is drawn from the intermediate circuit 110 than is supplied to it. The factor is therefore greater than 1. This can be realized, for example, via the capacitors 180 in the intermediate circuit 110 as intermediate circuit capacitance, from which voltage is drawn. However, if the comparison shows that the intermediate circuit voltage is too low, the following happens: in order to increase the intermediate circuit voltage, the drive control unit 6 is informed that the electric drive 130 should consume less power, i.e. less current. The factor is therefore less than 1. This can also be realized, for example, via capacitors in the intermediate circuit as intermediate circuit capacitance, which are charged with voltage.

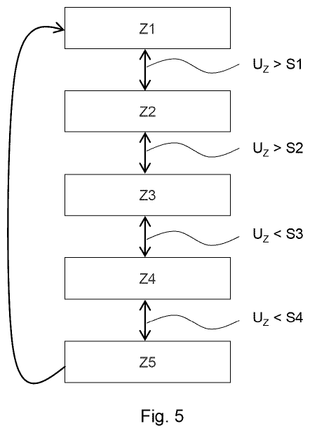

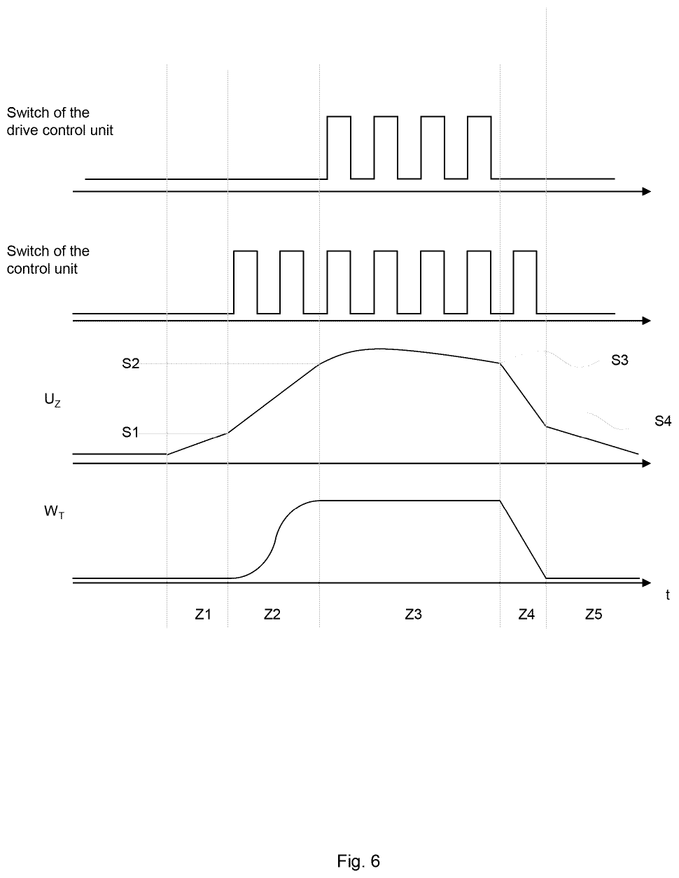

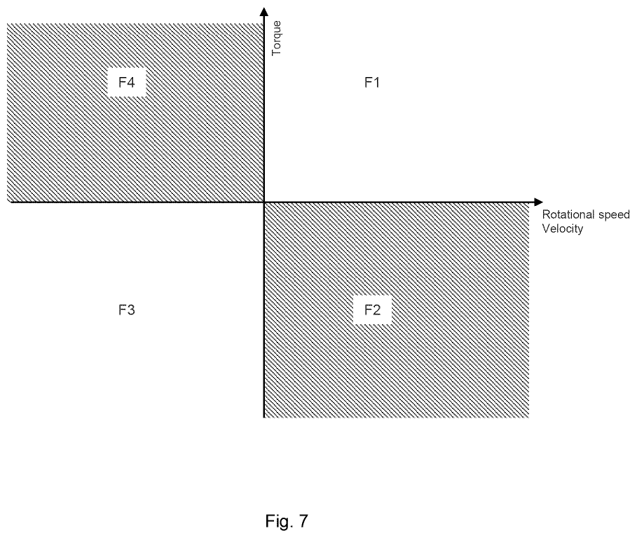

FIGS. 5 and 6 show various states that the intermediate circuit 110 can assume in the battery-free state. FIG. 5 shows a state machine implemented by the control unit 1, i.e. individual states and their transitions based on threshold value exceedances. The state machine defines various states in which the intermediate circuit 110 can be. For each state, there are certain actions that are possible (e.g. from a state Z1 to a state Z2) and certain actions that are not possible (e.g. from the state Z1 directly to a state Z3). The state machine also indicates how to get from one state to the next and which conditions must be reached in which order, FIG. 6 shows in the first line whether the drive control unit 6 is active and in the second line whether the control unit 1 is active. As soon as control unit 1 or drive control unit 6 is active, the corresponding switches are switched on and off at high frequency, i.e. up to 40 kHz. In the third line, FIG. 6 shows a voltage curve of the intermediate circuit voltage U_{Z}, and in the fourth line it shows a pedal resistance W_{T} in the form of a torque that a user experiences in the various states.

In state Z1, the vehicle, in particular the chainless cargo bike 100, is motionless and the control unit 1 is inactive. A user supplies power to the generator 120 in state Z1, for example by moving the pedals of the cargo bike 100 by means of a pedalling movement. The power supply leads to a slight increase in the intermediate circuit voltage U_{Z}, shown in the third line of FIG. 6. No pedalling resistance W_{T} is yet imposed on the generator 120, so that the user only experiences minimal mechanical resistance when pedalling, for example due to bearing friction. As soon as sufficient energy has been supplied to the intermediate circuit 110, i.e. a first threshold value S1 has been reached, the control unit 1 changes from the inactive state to the active state, as shown in the second line of FIG. 6. The first threshold value S1 can be a first threshold voltage, which is reached, for example, after a quarter turn of the pedals. The first threshold voltage can, for example, be greater than 10 V and less than 80 V, in particular between 20 V and 30 V. The first threshold voltage is, for example, below the set value of the intermediate circuit voltage. State Z2 is then reached, as indicated by the state machine in FIG. 5.

In state Z2, the vehicle is stationary and control unit 1 is active. The control unit 1 is therefore able to exchange signals with the generator 120, for example bidirectionally, via the generator interface 4. If the user continues to supply power to the generator 120 in state Z2, the intermediate circuit voltage U_{Z} continues to rise. In state Z2, the pedalling resistance W_{T} of the generator 120 can be increased continuously and differentially so that, for example, more force is required for a pedalling movement, as shown in the third line of FIG. 6. The system according to the disclosure thus solves the following problem: If the pedalling resistance W_{T} were not increased, it would increase abruptly at the moment in which the control unit 1 switches to the S3 state (see description below) and power is thus passed on from the intermediate circuit 110 to the electric drive 130. The sudden increase would lead to a sudden increase in pedalling resistance, which the user would not expect and would possibly stop pedalling. This would in turn lead to a voltage drop, which would return the system to the initial state Z1. Increasing the pedal resistance W_{T} therefore ensures robust control. The pedal resistance WT is increased by electrically controlling the coils of the generator 120 in such a way that the current in the coils increases and flows via the control unit 1 into the intermediate circuit 110. Thus, if the generator 120 is a three-phase generator, the control unit serves as a rectifier.

In state Z2, the vehicle remains motionless because the drive control unit 6 and with it the electric drive 130 are still inactive. Instead, the power supplied by the user is used to bring the intermediate circuit 110 and the components arranged therein, such as the capacitors 180, the control unit 1 and the drive control unit 6, to a certain energy level. The determined energy level can be a second threshold voltage as the second threshold value S2. The second threshold voltage can, for example, be greater than 40 V and less than 100 V, in particular between 50 V and 70 V. The second threshold voltage can correspond to the setpoint value of the intermediate circuit voltage or be slightly below it, for example 5% below the setpoint value. The fact that the second threshold voltage is below the setpoint value of the intermediate circuit voltage means that the vehicle can start driving even if it is only just becoming apparent that the desired intermediate circuit voltage will soon be reached. This increases driving comfort. As soon as the intermediate circuit voltage U_{Z} exceeds the second threshold value S2, for example after a further quarter turn of the pedals, the control unit 1 sends a signal to the drive control unit 6 so that the drive control unit 6 switches from the inactive to the active state. State Z3 is then reached.

In state Z3, the drive control unit 6 is active, so that electrical power is supplied to the electrical drive 130. If the user continues to supply power to the generator 120 in state Z3, in contrast to state Z2, this power is no longer used to increase the intermediate circuit voltage U_{Z}, but as drive power. The electric drive 130 thus moves the vehicle based on the power that is supplied to the intermediate circuit 110 via the generator 120. The intermediate circuit voltage U_{Z} remains essentially constant in state Z3 due to the regulation by the control unit 1. This enables the vehicle to be operated exclusively via the power supplied by the generator 120 and the intermediate circuit 110 does not collapse despite the relatively very low intermediate circuit voltage. In state Z3, the vehicle is controlled in such a way that the fluctuating power of the generator 120 is converted into a correspondingly varying power of the electric drive 130. In state Z3, it is thus possible to drive a chainless cargo bike 100, for example, without a drive battery. If a user pedals harder, the generator 120 generates more electrical power, which in turn is used as drive power for the electric drive 130. However, if a user pedals less, the generator 120 in turn generates less electrical power, which leads to a drop in the drive power of the electric drive 130. It is possible to keep the pedal resistance W_{T} constant, for example in the range between 20 and 50 Newtonmeter (Nm), even if the speed of the pedals varies, for example between 30 and 80 revolutions per minute. If a user stops pedalling and the intermediate circuit voltage falls below the second threshold value S2, the vehicle returns to the Z2 state. By keeping the intermediate circuit voltage constant as a control input at the reference variable of the setpoint value of the intermediate circuit voltage, it is possible to maintain the intermediate circuit 100 with varying input power. As long as the intermediate circuit voltage is above the third threshold value S3, the vehicle is operated exclusively by the power that the user supplies to the generator 120. Only as soon as the intermediate circuit voltage falls below a third threshold value S3, for example because the user no longer supplies sufficient power to the generator 120, is the drive control unit 6 deactivated so that the electric drive 130 no longer drives the vehicle. The third threshold value S3 can, for example, be around 10% lower than the second threshold value S2. Alternatively, the third threshold value S3 and the second threshold value S2 can be the same. State Z4 is then reached.

In state Z4, the vehicle is no longer driven, drive control unit 6 is inactive and control unit 1 is active. The user has stopped supplying power to generator 120. The intermediate circuit voltage U_{Z} therefore continues to drop. The vehicle is coasting or is already stationary because the drive control unit 6 is inactive. As soon as the intermediate circuit voltage U_{Z} falls further below a certain energy level, such as a fourth threshold voltage as the fourth threshold value S4, the control unit 1 also goes into the inactive state. State Z5 is similar to state Z1 in terms of its switch positions. The fourth threshold value S4 can, for example, be around 10% lower than the first threshold value S1. Alternatively, the fourth threshold value S4 and the first threshold value S1 can be the same. State Z5 is then reached.

In state Z4, the vehicle is no longer driven, drive control unit 6 is inactive and control unit 1 is active. The user has stopped supplying power to generator 120. The intermediate circuit voltage U_{Z} therefore continues to drop. The vehicle is coasting or is already stationary because the drive control unit 6 is inactive. As soon as the intermediate circuit voltage U_{Z} falls further below a certain energy level, such as a fourth threshold voltage as the fourth threshold value S4, the control unit 1 also goes into the inactive state. State Z5 is similar to state Z1 in terms of its switch positions. The fourth threshold value S4 can, for example, be around 10% lower than the first threshold value S1. Alternatively, the fourth threshold value S4 and the first threshold value S1 can be the same. State Z5 is then reached.

State Z5 is similar to state Z1 in terms of the activation of the individual components. As soon as the first threshold value S1 is exceeded again starting from state Z5 or Z1, the system switches to state Z2 as described above.

FIG. 7 shows four states from which the control unit 1 can regulate the electric drive 130 in individual states. In this embodiment, the state detector, which detects whether the drive battery unit 140 is actively connected to the intermediate circuit 110, can additionally detect in which of the states F1 to F4 the vehicle is being operated. In the F1 field, the vehicle accelerates into a forward movement and the electric drive 130 converts the supplied power into a rotational movement of the rear wheel hub. In this state, the vehicle is driven forwards. This higher-level state was described above. In the field F2, the vehicle brakes during a forward movement. The speed is therefore positive, but the torque is negative. Power could be taken from the electric drive 130 via the negative torque and fed to the intermediate circuit, but this would have a detrimental effect on the intermediate circuit voltage and the generator. Therefore, after corresponding detection of field F2 by the status detector, the control unit 1 provides for the electric drive 130 to be disconnected from the intermediate circuit 110. In this state, there is therefore no power exchange between the electric drive 130 and the intermediate circuit 110. The power that can be generated from the torque is therefore not supplied to the intermediate circuit 110. In the field F3, the vehicle accelerates in a reverse movement and the electric drive 130 converts the supplied power into a rotational movement of the rear wheel hub. In this state, the vehicle is driven backwards. This state is essentially the same as that of field F1. When the state detector detects this state, the control unit 1 ensures that the intermediate circuit 110 and the electric drive 130 are connected to each other. If they were previously disconnected, this disconnection is removed again in state F3, just as in state F1. In state F4, the vehicle brakes during a reverse movement. The speed is therefore negative, but the torque is positive. This state is disadvantageous for the same reasons as state F2. Therefore, after corresponding detection by the state detector, the control unit 1 also provides in this state F4 that no power exchange takes place between the electric drive 130 and the intermediate circuit 110. The power that can be generated from the torque is therefore not supplied to the intermediate circuit 110. This means that the electric drive 130 is not used for braking, which is why the generator 120 and the control unit 1 can ignore braking signals.

As far as applicable, all the individual features shown in the embodiments may be combined and/or interchanged without departing from the scope of the present disclosure.

1. A control unit for use in an intermediate circuit of a chainless cargo bike, the intermediate circuit electrically connecting a generator and an electric drive, the control unit comprising:
a control module configured to:
receive a setpoint value as a reference variable and an actual value as a control input, and
output a control variable,
the control input and the reference variable having equal physical dimensions;
an evaluation module configured to determine an actuating variable from the control variable, which actuating variable influences the control input at least indirectly in such a way that the actual value approaches the setpoint value; and
a drive interface configured to communicate with the electric drive,
the control unit being configured to determine an intermediate circuit voltage present in the intermediate circuit, and to use the intermediate circuit voltage as the control input.

2. The control unit according to claim 1, further comprising a status detector configured to detect whether a drive battery unit is actively connected to the intermediate circuit, wherein the control unit is configured to use the intermediate circuit voltage as the control input only if the drive battery unit is not actively connected to the intermediate circuit.

3. The control unit according to claim 2, wherein the control unit is further configured to, when the drive battery unit is not actively connected to the intermediate circuit, deactivate a brake of the electric drive, which is configured to absorb a torque acting in an opposite direction to the drive direction.

4. The control unit according to claim 2, further comprising a switch apparatus for opening and closing a battery switch, which is arranged between the drive battery unit and the intermediate circuit, wherein the switch apparatus is configured to open the battery switch when the status detector has detected that the drive battery unit is not actively connected to the intermediate circuit, wherein the battery switch is part of a battery management system of the drive battery unit.

5. The control unit according to claim 1, wherein the actuating variable is a drive power of the electric drive, wherein the drive interface is configured to indicate the drive power to the electric drive, so that the intermediate circuit voltage is adjustable via the drive power.

6. The control unit according to claim 1, further comprising a generator interface, which is configured to receive a generator parameter from the generator, wherein the generator interface is configured to activate the generator only when the intermediate circuit voltage has reached a first threshold value.

7. The control unit according to claim 1, wherein the drive interface is configured to output the actuating variable to the electric drive only when the intermediate circuit voltage has reached a second threshold value.

8. The control unit according to claim 6, wherein the evaluation module determines the actuating variable via a factor by which the generator parameter is to be multiplied, in order to obtain a drive power as actuating variable.

9. The control unit according to claim 8, wherein the factor varies as a function of the generator parameter and in particular lies in a range between 0.8 and 1.2.

10. The control unit according to claim 6, which is configured to decrease the drive power of the drive when the generator parameter is decreased in order to increase the intermediate circuit voltage, and/or
increase the drive power of the drive when the generator parameter is increased in order to decrease the intermediate circuit voltage.

11. The control unit according to claim 6, wherein the generator parameter proportionally depends on a fluctuating pedalling power, which a user applies to the chainless cargo bike.

12. The control unit according to claim 1, wherein the setpoint value of the intermediate circuit voltage can be pre-set and the actual value of the intermediate circuit voltage deviates by less than 15%, in particular less than 10%, from the setpoint value of the intermediate circuit voltage, wherein the deviation depends on a clocking of the control unit.

13. A generator unit for integration into an intermediate circuit, comprising:
the control unit according to claim 1; and
a generator integrated into a pedal crank of a cargo bike.

14. A vehicle comprising:
the generator unit according to claim 13;
a motor unit including the electric drive and a drive control unit for adjusting a driving power of the electric drive; and
the intermediate circuit;
wherein the electric drive and the generator are purely electrically coupled to each other, and wherein the vehicle is a chainless cargo bike having a pedal crank and a rear wheel assembly, wherein the generator is integrated into the pedal crank and the electric drive is integrated into the rear wheel assembly.

15. The vehicle according to claim 14, further comprising a drive battery unit, that is selectively connectable to the intermediate circuit, wherein a status detector recognizes whether the drive battery unit is actively connected to the intermediate circuit.

16. The vehicle according to claim 14, wherein the vehicle is a chainless cargo bike having a pedal crank and a rear wheel assembly, wherein the generator is integrated into the pedal crank and the electric drive is integrated into the rear wheel assembly.

17. A method for adapting a drive power of an electric drive of a chainless cargo bike to an output power of a generator of the chainless cargo bike, the method comprising the steps of:
a. determining an actual value of an intermediate circuit voltage present in an intermediate circuit electrically connecting the generator and the electric drive;
b. determining a generator power, which depends on a fluctuating pedal power, which a user applies to a vehicle;
c. determining a setpoint value of the intermediate circuit voltage, which can be preset;
d. determining a control deviation between the actual value of the intermediate circuit voltage and the setpoint value of the intermediate circuit voltage; and
e. adapting the drive power of the electric drive as a function of the control deviation.

18. The method according to claim 17, further comprising the following steps after step d. and before step e.:
determining a factor by which a drive power results from the generator power, by multiplying the generator power by the factor, and determining the drive power;
transmitting the drive power to a drive control unit; and
adapting the drive power of the electric drive to the transmitted drive power in order to adapt the actual value of the intermediate circuit voltage to the setpoint value of the intermediate circuit voltage.

19. The method according to claim 17, wherein steps a.-e. are carried out continuously in order to variably determine the drive power with the fluctuating generator power such that the setpoint value of the intermediate circuit voltage is continuously controlled.

20. The method according to claim 17, wherein at least one of:
step b is only performed when the intermediate circuit voltage has exceeded a first threshold value; and
step e is only carried out when the intermediate circuit voltage has exceeded a second threshold value.
